(19) United States
(12) Patent Application Publication
(10) Pub. No.: US 2003/0173012 A1
(43) Pub. Date: Sep. 18, 2003

(54) Conventional inner tube adapter

(76) Inventor: D. Jose Carlos Jimenez Rivero, Sevilla (ES)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/297,414

(22) PCT Filed: Feb. 4, 2002
(86) PCT No.: PCT/ES02/00052

(51) Int. Cl. B60C 29/00

(52) U.S. Cl. 152/429

(57) ABSTRACT

An inner tube adapter for a tubeless tire is disclosed including a bulb-shaped body having an internal bore, wherein the internal bore is threaded along at least a portion of its length, the internal bore for surrounding at least a portion of a valve having a body and an end section and secured by an adhesive, and wherein the end section extends outside of the internal bore.

### CROSS-REFERENCES TO RELATED APPLICATIONS

This application claims the benefit of PCT/ES02/00052 filed on Feb. 4, 2002, entitled CONVENTIONAL INNER TUBE ADAPTER.

### OBJECT OF THE INVENTION

The present invention relates to an adapter for a motor vehicle tire inner tube, which may be used in tires not requiring a tube, thereby improving the performance of the vehicle considerably. In particular, the present invention is marked by the ease with which it may be installed and repaired.

### PRIOR ART

Powered vehicles using tires have continued to develop since they were initially introduced. Throughout the history of the tire, there has been an ongoing search for the way to achieve the best possible contact of the vehicle with the ground.

At present there are two main types of motor vehicle tire, which may be divided into:

1. Tires that have an inner tube; and

2. Tires that are not provided with an inner tube.

Although these two types of tire have similar features, they also exhibit noticeable differences in performance. The invention referred to in this application largely solves the problems associated with each of the two types of tire, achieving a “hybrid” of the two that combines the best features of both.

### SUMMARY OF THE INVENTION

The tube to be adapted is a conventional inner tube with the same physical properties as any of those fitted to motor vehicles today. The innovation lies in the valve that is attached to the aforesaid tube. Hitherto inner tubes have been made in such a way that the valve is attached thereto by means of a vulcanizing process, leading to a final arrangement of the components as may be seen in FIG. 1.

The present invention is based on adapting this valve to one of similar characteristics to those used on other types of tires. Specifically, the innovative feature of the present invention is the modification of this valve so that it works in the same way as one of the type used on tubeless tires. The invention proposed does not entail a modification of the original tube, rather, to achieve the objective, it suffices to modify the rubber body of the valve used in tubeless tires by providing a body with an internal thread by which it is attached to the valve that is normally fitted to tubed tires (shown in FIG. 3).

The tube that is the object of this invention offers a solution to a series of technical problems associated with the two types of tire that are currently fitted to motor vehicles. These two problems can be summarized as follows:

1. When a tubeless tire is working at low pressure, an impact with an object having a jutting edge may displace the tire bead, so that the air escapes from the inside, thereby requiring that it be repaired. This situation arises when operating vehicles on muddy or sandy terrain, as tire pressure is lowered in these circumstances in order to achieve a larger ground contact area, thereby reducing the depth to which the vehicle sinks into the ground. This problem may also arise on any urban vehicle where the owner has not followed a proper maintenance schedule. With tubed tires this problem does not arise, as bead displacement would not lead to a loss of air pressure since the inner tube would prevent it.

2. When compared with a tubeless tire, a tubed one has the disadvantage that in the event of its being punctured, it quickly loses the air pressure it contains because air leaks occur in the area where the tube valve is installed. This does not happen with tubeless tires, however, as the valve they have fitted prevents the air from escaping through the hole in the wheel of the vehicle where it is mounted.

It may be seen that the tube proposed by the invention overcomes both of the problems set forth above in that:

1. In the event of a puncture, the tire would behave like a tubeless tire, as leakage past its valve is prevented.

2. In the event of bead displacement, air leakage would not take place since the tire would behave like a tubed tire.

Accordingly, this new tire represents an improvement in tire performance over currently existing ones, as well as an improvement in the passive safety of the vehicle since, in case of accident, we increase the possibility of keeping the tires full of air, so that the steering and manoeuvrability of the vehicle are retained for a longer time.

### BRIEF DESCRIPTION OF THE DRAWINGS

FIG. 1 is a side view illustration of a valve like those used on tubed tires.

FIG. 2 is a side view illustration of the object of the invention.

FIG. 3 is a side view illustration of the object of the invention fitted to a conventional tire inner tube valve.

DETAILED DESCRIPTION OF THE PREFERRED EMBODIMENT

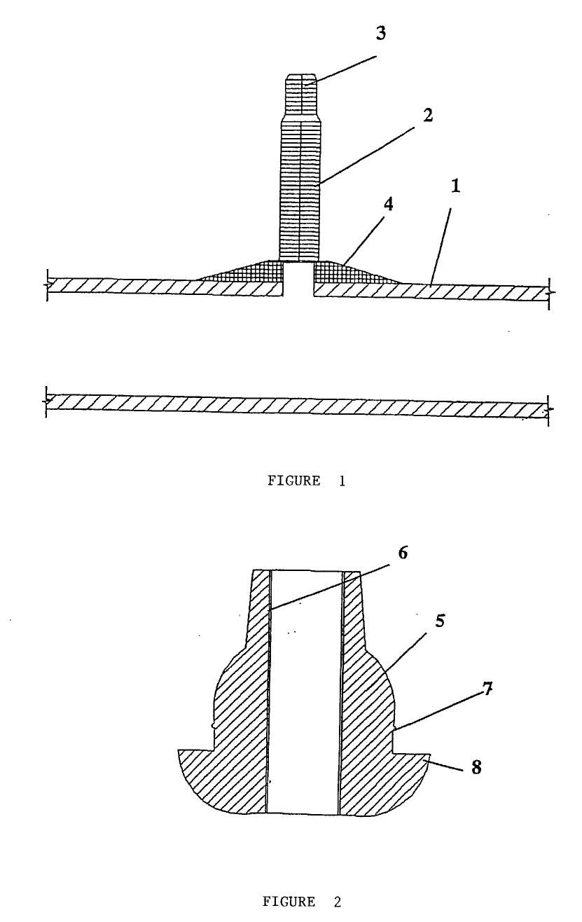

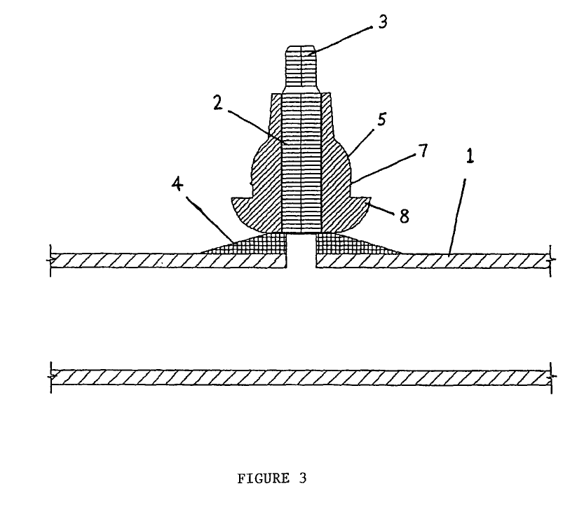

In the light of the above-mentioned figures, it may be observed in FIG. 1 that the device is constructed of one piece that is attached to the body 2 of the valve 4 of a conventional inner tube secured to the latter by vulcanizing, with the result that it may be used on tires not intended for the use of inner tubes.

As illustrated in FIGS. 1 and 2, the piece that is the object of the invention consists of a single bulb-shaped body 5, in which an internal bore 6 is drilled and which is threaded for securing it to the valve core 2. The dimensions are variable so that the end section 3 of the valve core 2 projects so as to be able to fit the valve cap.

In order to assure the tightness of the joint and make certain that no air escapes past this contact surface, it is preferred that an adhesive be applied to said surface at the time of installation.

The outside surface of the object of the invention is provided with a series of shoulders 7 and 8. Shoulders 7 and 8 are provided so as to ensure that, when installed on a tire not requiring an inner tube, the assembly fits snugly to the wheel rim and cannot move.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. An inner tube adapter for a tubeless tire comprising:
a bulb-shaped body having an internal bore, wherein said internal bore is threaded along at least a portion of its length;
said internal bore for surrounding at least a portion of a valve having a body and an end section and secured by an adhesive, and
wherein said end section extends outside of said internal bore.

2. The inner tube adapter according to claim 1 wherein said valve is a long-core valve.
